(19) United States
(12) Patent Application Publication
(10) Pub. No.: US 2008/0028477 A1
(43) Pub. Date: Jan. 31, 2008

(54) Chip with Power Supply Device

(76) Inventors: Mirko Lehmann, Freiburg (DE); Ulrich Sieben, Reute (DE)

Correspondence Address: O'SHEA, GETZ & KOSAKOWSKI, P.C., 1500 MAIN ST., SUITE 912, SPRINGFIELD, MA, 01115, US

(21) Appl. No.: 11/579,213

(22) PCT Filed: Feb. 2, 2005
(86) PCT No.: PCT/EP05/01033

§ 371 Date: Dec. 20, 2006

(30) Foreign Application Priority Data
Apr. 30, 2004 (DE) 10 2004 021 346.1

(51) Int. Cl. G06F 1/26; G08B 29/16

(52) U.S. Cl. 726/36

(57) ABSTRACT

A chip includes a memory that stores confidential data, a power supply device to apply a voltage and/or or a current, and an interface to transfer the data from and/or to another device. To secure the data in the memory, the power supply device is an integrated component of the chip. The power supply device is equipped with a limited, non-replenishable fuel reservoir so that data can be maintained in the memory over a limited service life. In other embodiments, voltage provided by the power supply device can also be employed actively to delete data in the memory in the event of unauthorized access to the chip.

### PRIORITY INFORMATION

This patent application claims priority from International patent application PCT/EP2005/001033 filed Feb. 2, 2005 and German patent application 10 2004 021 346.1 filed Apr. 30, 2004, which are hereby incorporated by reference.

### BACKGROUND OF THE INVENTION

The invention relates in general to integrated circuits or chips, and in particular to a chip with a power supply device.

The electrical voltage supply or current supply for chips, that is, various types of integrated circuits and the like, typically comprises an operating voltage applied by an external power source. External power sources typically include a power grid, or batteries or secondary cells employed in electrical devices.

It is also possible to employ fuel cell systems in place of batteries or secondary cells. Fuel cells typically are composed of a first and a second electrode arrangement. One electrode arrangement serves as the anode and the other electrode arrangement serves as the cathode. A membrane electrode assembly (MEA) with a catalytic capability is located between the two electrode arrangements. The assembly acts as a proton-permeable membrane having a catalytic coating. In addition, a fuel cell of this type has a fuel supply device to supply a fuel, typically hydrogen, and a reactant supply device to supply a reactant, typically oxygen. To generate a current, the reactant reacts with protons that come from the fuel and have passed through the membrane. The end product of combustion, typically water, is discharged from the fuel cell arrangement.

Often chips have an integrated circuit to store confidential data. Such confidential data could be, for example, account access information for an account and identification information for a person. If the chip should fall into unauthorized hands, a fundamental risk exists that the data contained in the chip could be read by an unauthorized person and be misused.

To protect a chip against tampering, there exist solutions of at most limited usability, for example, anti-drill-protection films which are integrated into a package of a chip.

One approach is generally known from Published PCT Patent Application WO 02/058219 A2 involving an energy storage device, the surface of which is designed to take up the energy of a supplied medium, the energy being stored in an adjacent semiconductor arrangement. The arrangement uses the energy to generate light or electromagnetic radiation. Thus, surface energies are utilized in this arrangement.

What is needed is a chip with a power supply device, where the data stored in the chip are better secured, in particular, better secured against unauthorized access.

### SUMMARY OF THE INVENTION

Briefly, in accordance with an aspect of the invention, a chip with a memory that stores, for example, confidential data, includes a power supply device that applies a voltage and/or a current, and an interface that transfers data from and/or to another device if the power supply device is a component, for example, an integrated component, of the chip. Operationally-relevant components of the chip, such as, for example, the memory with the data, can thus access an independent power supply device which is utilizable to secure the confidential data in the memory.

In one embodiment of the chip, a maintenance voltage is applied to the memory to maintain the data, where the data are deleted in the event the maintenance voltage is lost, and where the maintenance voltage is supplied, for example exclusively by the power supply device. An implementation is also possible on arrangements having external, that is, nonintegrated, power supply devices. This embodiment has the effect that the data in, for example, a RAM (random access memory) are stored only as long as the voltage supply device is able to supply a sufficient maintenance voltage. As a result, the service life of the confidential data, or the service life of the complete chip, is limited to a time period that is predeterminable by appropriately dimensioning the power supply device. A smart card, used, for example, by bank customers in banking transactions, can thus be limited to a predetermined duration of function. Limitation of usability is thus secured not only by an expiration notice printed on the card or a possible locking flag in the central database, but also by a general maximum service life of the chip or the card.

In a second embodiment which may also be combined with the first embodiment, the chip includes a security wire that connects the memory and the power supply device to each other to apply the maintenance voltage. The security wire may be arranged continuously in the chip so that the security wire is interrupted if the chip is damaged. Mechanical damage to the chip or to the package of the chip thus causes the security wire to be interrupted, which results in an immediate interruption of the provision of the maintenance voltage to the memory. As a result, confidential data in the memory are lost or deleted. The possibility of opening the chip so as to, after exposing the actual integrated circuit, gain direct access to the circuit board conductors is thus excluded by use of the security wire.

In a third embodiment, the chip has a security circuit that destroys operationally-critical components of the chip in the event of unauthorized intervention. The integrated power supply device preferably provides an operating voltage for the security circuit. Implementation is also possible on arrangements having external, nonintegrated power supply devices. Combined therewith or alternatively thereto, the chip can also include a security circuit that deletes the data in the memory, for example, a ROM (read-only memory), in the event of unauthorized intervention, where the power supply device supplies an operating voltage for the security circuit. In this embodiment, the chip thus has a security circuit which accesses an independent power supply device. Detaching the chip from a circuit with an external power supply thus does not impede the functionality of the security circuit.

The arrangement, in particular, the security circuit, provides protection of, for example, encrypted data in the chip, this protection being adaptable to any specific design. In the event of an unauthorized attempt to read the data, the energy on the chip may be used to clear the RAMs and/or ROMs. With the RAMs of, for example, the first embodiment described above, maintenance of the data incurs an expenditure of energy such that any loss or switching off of power results in the data being deleted. With ROMs of, for example, the third embodiment described above, maintenance of the data incurs no energy costs such that an active deletion of the data stored in the ROMs is implemented with energy.

The security circuit can be implemented using sensors, such as, for example, gas sensors, ultrasound sensors, magnetic field sensors, optical sensors, biosensors, etc., which trigger an alarm or activate another function of the security circuit if the chip enters an operationally-hostile environment and appropriate triggering criteria for the sensors are met, or alternatively, if specified environmental conditions are lost. Thereupon, security-relevant and confidential data on the chip, or even all of the data, may be deleted.

In a variant of this third embodiment, the security circuit monitors an applied operating voltage and -deletes the data in the event of any interruption of the operating voltage. Any detachment of the chip from its operating environment thus results, due to the interruption of the operating voltage, in activation of the security circuit which, using an independent power supply device, causes the data in the memory to be deleted.

In yet another variant of the third embodiment, which may also be combinable with the previous variant, the security circuit is formed from a barrier for a reactant to operate a fuel cell with a fuel as the power supply device, where any damage to the barrier results in the reactant being admitted into the fuel cell. In other words, the power supply device is formed from a fuel cell in which a fuel, in particular, hydrogen, is integrated. For the fuel cell to supply a voltage for the security circuit, however, it lacks the reactant, for example, oxygen. The barrier can be formed by a separate protective shell around the components of the chip to be secured which, in the simplest case, is formed by the package of the chip. Damage to the barrier or to the package results in the admission of air, and thus oxygen, with the result that the fuel cell is activated and a voltage is applied as the deletion voltage to the security circuit which then causes the data in the memory to be deleted.

While the first two embodiments described above are based on the fundamental principle of providing a separate maintenance voltage to maintain the data in the memory of the chip, the variants of the third embodiment provide a security circuit which actively effects deletion of the data in the memory in response to an unauthorized intervention. The term “memory” is understood here to mean any device that stores data.

A chip operated based on the various embodiments has a terminal for the purpose of applying a voltage to operate the general functions of the chip from an external voltage source. This embodiment allows for the provision of an integrated power supply device having a relatively low voltage capacity since the power-intensive functions for operation of the chip can be supplied by an external voltage source. Using this approach, the operating voltage may be supplied, for example, through contacts or inductively. In particular, with this embodiment the integrated power supply device is used with an emergency power circuit to supply the operating voltage from the power supply device in the event the operating voltage from the external voltage source is lost. As a result, transient disturbances of the external operating voltage, in particular, can be buffered.

For all of the embodiments, the power supply device may be a fuel cell with a specified quantity of fuel. The fuel is stored, for example, in a palladium storage unit. The use of a fuel cell offers the advantage that power or capacity losses, due to an increase in storage time, can be lower than with other voltage sources. The specified quantity of fuel may be limited to supply a quantity of current for a certain service life of the chip or of the memory content. As a result, the fuel cell is such that replenishment of consumed fuel is difficult if not impossible. In particular, with a fuel cell as the power supply device to supply a maintenance voltage for confidential data in the memory, the service life of the overall chip can be set for a specified maximum time span. In the event the maintenance voltage is lost or the unit falls below a threshold voltage value, the confidential data in the volatile memory is lost.

A chip having confidential data may contain a key or the like to operate the chip. For example, during fabrication the chip can be provided with a key, for example, a cryptological key or a random number, where this type of confidential data are required to operate the chip or to utilize any other data stored thereon. In the event of a disturbance of operation or unauthorized access, the confidential data are deleted or overwritten with invalid data to make the chip or data stored thereon unusable. With this approach, only the chip knows its key or its corresponding confidential data.

It is also possible for the chip itself to generate its own key which is known only to the chip itself. This key generation may occur using a random-number generator during the fabrication of the chip, or at a later point in time. The power supply device may cover the memory area in which the key is stored, or may protect this memory area. The chip may have a random number generator to generate the key required to operate the chip and stored in the memory. The random number generator may generate the key during fabrication or initial activation of the chip.

The memory area with the confidential data may be secured or powered solely by the power supply device (e.g., a fuel cell), thus allowing any external batteries or the like for this purpose to be dispensed with.

The loading of erroneous data into a memory area can be implemented in the event of an unauthorized access to the memory area or the chip or the like. This can occur instead of deleting data or destroying relevant operating components. Any unauthorized reading of these data then results in the unauthorized person not being able to use these data in any way, or possibly suffering some harm, or also being detectable by appropriate monitoring.

In addition to the possibility of locating the fuel cell as the power supply device next to other components within the package of the chip, the power supply device may be an integral component of the actual memory.

Preferred applications include identification cards and credit cards with this type of chip which has the memory to store confidential data and the power supply device with a limited amount of current to store the data in the memory for a predetermined duration.

In terms of their technical features, the individual exemplary embodiments described above can be combined with each other to form additional embodiments.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 illustrates an embodiment of a chip having an integrated power supply device;

FIG. 2 illustrates a chip having an integrated power supply device and having a security wire to prevent unauthorized access to components within the chip;

FIG. 3 illustrates an embodiment of a chip that has a security circuit supplied with a voltage from an integrated power supply device; and

FIG. 4 illustrates an embodiment of a chip having a security circuit.

### DETAILED DESCRIPTION OF THE INVENTION

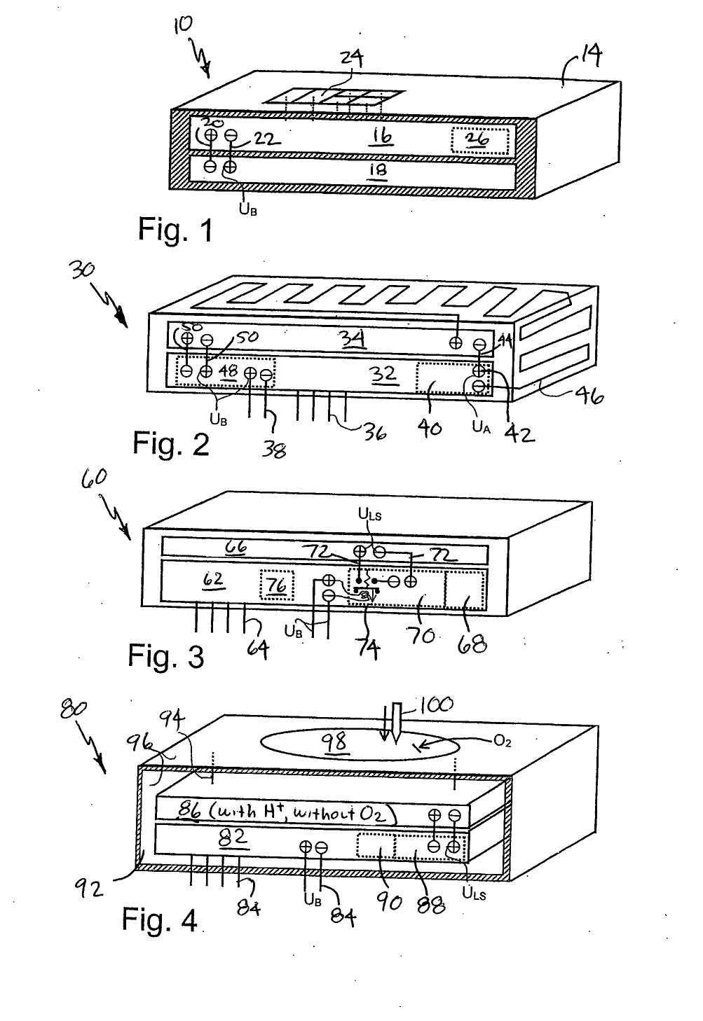

FIG. 1 illustrates a chip 10 comprising a credit card with an integrated smart card 14. In addition to a processor 16, a power (e.g., voltage) supply device 18 is also integrated in the chip 10. Any voltage supply device 18 analogous to conventional batteries can be used. What is preferred in particular, however, is a fuel cell as the voltage supply device 18. The voltage supply device 18 supplies an operating voltage U_{B} for the processor 16. The operating voltage U_{B} is applied to the processor 16 through corresponding connection lines 20, 22 between the voltage supply device 18 and the processor 16.

The processor 16 can be any known integrated circuit connected to an interface 24 to transfer data to an external device. The interface 24 may be formed by a contact field on the surface of the chip 10 or the smart card 14.

A memory 26 is integrated in the chip 10 to effect the volatile buffering or permanent storage of data. In addition to the integration of the memory 26 in the processor 16, the memory 26 can also be provided as a separate module along with the processor 16 and the voltage supply device 18. The memory 26 can also be connected directly to the voltage supply device 18 or may comprise a component of the module of the voltage supply device 18.

The chip 10 illustrated offers the advantage of an independent voltage supply for the processor 16 with the operating voltage U_{B} from the voltage supply device 18 integrated in the chip 10. The operating voltage U_{B} can be used, for example as the maintenance voltage for the data stored in the memory 26.

For example, a first electrode of the fuel cell 18 composed of a palladium layer with an area of 1 mm² and a thickness of 1 μm can be saturated with, for example, hydrogen as the fuel during the fabrication process. The object of such an arrangement is for hydrogen to suffice by itself. That is, to not provide any additional feed devices for hydrogen or analogous energy carriers. The oxygen supply can comprise ambient air. As a result of the one-time charging with hydrogen, preferably clocked semiconductor circuits can in this way be supplied using this chip-integrated current source to create, for example, a stand-alone microsystem, such as, for example, an alarm system.

In the example described, a one-time charging of hydrogen can, according to initial calculations and as a function of diffusion conditions for the hydrogen, generate a ten-second current flow with a current strength of several hundred μA. Alternatively, designs can also be provided which allow for replenishing of the hydrogen. Simple semiconductor circuits or a chip 10 can be provided with an integrated current source to create an alarm system, for example. As a result, a sufficient quantity of energy is available on the chip 10 to operate a circuit, for example, the processor 16, or to supply the memory 26 with a maintenance voltage for an extended duration.

This type of integrated fuel cell 18 on the chip 10 thus enables a memory, for example a DRAM, a RAM and/or a field programmable gate array (FPGA) to be maintained on the chip 10.

If the data are confidential data and the memory 26 is a volatile memory, the data of which are lost or deleted upon interruption of the maintenance voltage, an additional advantage is provided in that damage to the chip 10 in the event of an interruption of the operating voltage U_{B} or the maintenance voltage inevitably also results in the loss of the confidential data. Tampering directly with the fuel cell 18 or in the region of the voltage supply of the memory 26 thus results in the data being deleted since the energy for maintenance is not present.

An exemplary chip 10 for digital signal processing (DSP) has, for example, a chip size of 225 mm² for the components to effect digital signal processing, and additionally of about 1 cm^{2×100} μm for the fuel cell 18. Given an operating frequency of 13.2 MHz, an operating voltage of 1.0 V, and a power consumption of 29 mW, the estimated stand-by power for a currently available chip would be 350 μW in the active state. In the inactive, sleep state, the estimated power consumption is 600 nW. Based on this assumption, the fuel cell 18 can supply 700 nW of power for a duration of 700 days. In the event the chip 10 is used as a component of a credit card or bank card, confidential data may be maintained in the memory 26 for 700 days. Thereafter the data would be lost due to the lack of a maintenance voltage, and the card with the chip 10 would become unusable for subsequent use. Loss of a card or destruction of a card prior to the official expiration date presents only a limited security risk.

Referring to FIG. 2, there illustrated is a chip 30 having an integrated circuit 32, for example, an EPROM (erasable programmable read-only memory), and a fuel cell 34 as an integrated voltage supply device. Conventional contact pins 36 for a chip 30, for example, serve as an external interface to transfer data. The EPROM integrated circuit is connected through two additional contact pins 38 to an external voltage source to supply an operating voltage U_{B}. The external connections 36, 38 can also be provided using other known approaches, for example, a cable connection or a wireless connection, for example, using the Bluetooth standard or using an inductive interface arrangement.

The chip 30 has a memory 40 to store data. In addition to confidential individual data values, the term data is also understood to mean any other forms of data, including source codes or program codes to operate an integrated circuit or an external device. The memory 40 has a maintenance voltage terminal 42 for the purpose of applying a maintenance voltage U_{A}. The maintenance voltage U_{A} is supplied from the integrated voltage supply device 34 or the fuel cell via a connection line 44. In addition to, for example, a direct connection of the voltage supply device 34 and the memory 40 in terms of a voltage pole, the connection of the other voltage pole is effected through a security wire 46. The security wire 46 is routed in the form, for example, of the finest wire possible on a coiled track along the inside of the package wall of the chip 30. The security wire 46 is thus arranged such that any damage to the package inevitably also damages the security wire 46, thereby interrupting the maintenance voltage U_{A} for the memory 40. Damage to the package of the chip 30 thus results in an interruption of the maintenance voltage U_{A}, and inevitably to deletion of the data stored in the memory 40.

An emergency circuit 48 is provided, in addition to the external terminal 38, to supply the operating voltage U_{B}. The circuit 48 has connections 50 to the internal integrated voltage supply device 34. In the event the external operating voltage U_{B} is lost, the operating voltage required to operate the integrated circuit is supplied by the integrated voltage supply device 34.

In the embodiment illustrated in FIG. 3, a chip 60 has an integrated circuit that may comprise a RAM 62. To apply an operating voltage U_{B} and to transfer data from and/or to external devices, the chip has one or more corresponding interfaces 64 in the form of contact pins. In addition, the chip 60 has a voltage supply device 66, preferably a fuel cell.

To secure data in a memory 68, the chip has a security circuit or deletion circuit 70. The security circuit 70 deletes the memory content or data in the memory 68 in the event of an unauthorized intervention. The security circuit 70 is connected through corresponding contacts 72 to the voltage supply device integrated in the chip 60 to enable data stored permanently in the memory 68 to be deleted in the event of an interruption of the operating voltage U_{B}. The voltage supply device 66 thus provides a voltage in the form of a deletion voltage U_{LS} to delete any stored data.

The security circuit 70 monitors the external operating voltage U_{B} applied to the chip 60 as a deletion criterion. In the event the external operating voltage U_{B} is interrupted, or this voltage drops below a specified threshold, the security circuit 70 is activated to delete the data in the memory 68. An electromagnetic switch 74 activates the security circuit 70. However, any other electronic switching or control mechanisms may also be used.

In this embodiment, the energy of the integrated voltage supply device 66 is thus used, for example, to conduct small current pulses through the chip 60 or its circuit components in the event an unauthorized access to the chip occurs. The current pulses are sufficiently strong such that the data in the memory 68 of, for example, an EPROM integrated programmable circuit is deleted.

It is possible to utilize other criteria in addition to the deletion criterion of lost operating voltage U_{B}. For example, damage to the package of the chip 60 or the effect of an external electromagnetic field can also be employed as the deletion criterion for the security circuit 70.

The chip 60 also has an internal clock 76, so that any tampering or attempts at tampering can be traced based on the internal clock 76. The internal clock 76 can also be used to effect an active deletion after a predetermined time period has elapsed.

While the chips 10, 30 of the embodiments of FIGS. 1 and 2 provide an internal maintenance voltage U_{A} for the corresponding memory 26, 40 that secures the data, the embodiment of FIG. 3 provides that a voltage be supplied from the internal voltage supply device 66 as the deletion voltage U_{LS} to delete the memory content in the event of an unauthorized intervention. A combination of the embodiments of FIGS. 1-3 is also possible. In this type of combination, for example, the voltage supplied by the internal voltage supply device 66 may be supplied both as the maintenance voltage U_{A} for the memory 68 as well as a voltage in the form of a deletion voltage U_{LS} for a security circuit 70 to actively delete data in the memory 68.

Alternatively or in addition to the application of a voltage in the form of a deletion voltage U_{LS} to delete data in the memory 68, destruction of the critical components of the chip 60 can also be implemented by the voltage supplied by the security circuit 70 or by the voltage supply device 66. For example, sufficiently strong current pulses can be emitted by the voltage supply device 66 such that circuit board conductors or integrated circuit structures critical to the function of the chip 60 are permanently destroyed.

In an embodiment illustrated in FIG. 4, a chip 80 has an integrated circuit 82 connected to external devices through an interface 84 for exchanging data as well as applying an external operating voltage U_{B}. In addition, the chip 80 has a voltage supply device 86 in the form of a fuel cell. The voltage delivered by the fuel cell 86 serves to supply a security circuit 88. Additionally or alternatively, the supply voltage U_{LS} can also be used as a maintenance voltage U_{A} for an integrated memory 90 with confidential data.

In FIG. 4, the arrangement of the integrated circuit 82 and the fuel cell 86 is surrounded by a gap 92 and attached by a retaining means 94 to a spatially removed inner wall of the package 96. No reactant (e.g., oxygen O₂) is located in the gap 92. A vacuum is preferably present in the gap 92 such that if the package 96 is damaged, ambient air abruptly enters the gap 92 at high speed. The ambient air contains the reactant O₂ required for the fuel cell 86. The fuel cell 86 itself has only the fuel, for example, hydrogen H⁺. Damage to the package 96 thus results in an activation of the fuel cell 86 which thereupon supplies the security circuit 88 with the deletion voltage U_{LS} to delete the data in the memory 90.

A barrier 98 is destroyed if the reactant is to be admitted into the fuel cell 86. Damage to the package 96 or the barrier 98 caused by sheer force or an object 100 thus results in the deletion of the data in the memory 90.

A plurality of variants on this embodiment is also possible. In addition to combinations with the above embodiments, these also include separate variants such as a barrier to a reactant reservoir which is similarly integrated within the package of the chip. This would also result in the deletion of the data in response to damage to the package if such damage were to be effected in a protective atmosphere or within an evacuated space.

What is preferred is the use of the above concepts for the integral supply for circuits, in particular, known integrated circuits. In particular, the energy can be also used to maintain data on the chip. For example, an 8 Mbit SDRAM from the Hitachi Company requires for this purpose a current of 6 μA given a voltage of 1.2 V. Another example is the model DS1374 circuit from MAXIM in which a voltage of 1.3 V and a current of 1 μA are required to maintain the data and to prevent someone from overwriting the internal registers in response to a loss of voltage. Here the energy is supplied externally by a Super-CAP or a battery. Based on the above embodiments, the energy may be supplied internally. The DS1374 circuit contains a battery-supported time counter, and alarm function, a programmable square-wave signal transmitter, and a reset input/output function in a 10-pin package. The circuit monitors the applied operating voltage and in the event of a loss of voltage protects the internal registers from being overwritten, executes a processor reset, and switches over to a protective power supply provided by the connected battery to prevent any degradation of the data. In the power-saving mode, the oscillator maintains its function during reduced power consumption. When the operating voltage returns to the normal state, the circuit holds the processor for a subsequent period of time in the reset state while the operating conditions stabilize. To provide a backup power supply for the circuit from a battery, an optional external maintenance protective circuit is available.

In the model DS1672 circuit from MAXIM, a first real-time clock for an extremely low supply voltage is connected to a voltage monitoring means and power failure switch. A counter communicates with the processor through a two-wire interface and counts seconds from which a software algorithm calculates the time of day, date, month, and year. The circuit monitors the supply voltage and in response to a power failure protects the data memory for timing, sends a reset command to the processor, and switches over to the emergency power supply to prevent any loss of data, this power supply in turn being provided by an external battery. In economy mode, the oscillator measures the time even given a significantly reduced supply voltage of 1.3 V and given a power consumption of less than 400 nA. Although the present invention has been illustrated and described with respect to several preferred embodiments thereof, various changes, omissions and additions to the form and detail thereof, may be made therein, without departing from the spirit and scope of the invention.

What is claimed is:

1. An integrated circuit, comprising:
a memory that stores data;
a power supply device that supplies power to the |memory; and
an input/output interface that transfers data to and from the integrated circuit.

2. The integrated circuit of claim 1, where the power applied to the memory comprises
a maintenance voltage that maintains the data stored in the memory where the data are deleted when the maintenance voltage is removed from the memory.

3. The integrated circuit of claim 1, further comprising a security wire that connects the memory and the power supply devices, where the security wire is disposed such that the security wire is interrupted if the integrated circuit is damaged thereby interrupting the application of power to the memory.

4. The integrated circuit of claim 1, further comprising a security circuit that destroys at least one predetermined component of the integrated circuit in the event of an unauthorized intervention, where the power supply device supplies power to the security circuit.

5. The integrated circuit of claim 1, further comprising a security circuit that deletes the data in the memory in the event of an unauthorized intervention.

6. The integrated circuit of claim 5, where the power supply device supplies power to the security circuit.

7. The integrated circuit of claim 1, further comprising a security circuit, where the security circuit monitors an applied, external operating voltage, and where when the applied external operating voltage is interrupted the security circuit takes action in the form of one of destroying at least one predetermined components of the integrated circuit, or erasing the data in the memory.

8. The integrated circuit of claim 1, where the power supply device comprises a fuel cell, and where the integrated circuit further comprises a security circuit, where the security circuit comprises barrier for a reactant to operate the fuel cell with a fuel, and where any damage to the barrier results in the admittance of the reactant into the fuel cell thereby causing the fuel cell to supply power.

9. The integrated circuit of claim 1, further comprising a terminal for the application of an external operating voltage that operates the integrated circuit from an external voltage source.

10. The integrated circuit of claim 9, further comprising an emergency circuit that supplies power to the integrated circuit from the power supply device if the external operating voltage from the external voltage source is lost.

11. The integrated circuit of claim 1, where the power supply device comprises a fuel cell that provides power to the integrated circuit for a predetermined amount of time.

12. The integrated circuit of claim 1, where the power supply device comprises a fuel cell having a predetermined amount of fuel to supply a quantity of electrical current for one of a predetermined service life of the integrated circuit and the data stored in the memory.

13. The integrated circuit of claim 1, where the power supply device is an integral component of the memory.

14. The integrated circuit of claim 1, where the data stored in the memory comprises a key that enables operation of the integrated circuit.

15. The integrated circuit of claim 14, further comprising a random-number generator that generates the key, where the key is stored in the memory, and where the key is generated during one of fabrication of the chip and initial activation of the integrated circuit.

16. The integrated circuit of claim 1, further comprising a security circuit that loads erroneous data into the memory in the event of an unauthorized intervention within the integrated circuit.

17. The integrated circuit of claim 1, further comprising a security at least one sensor that performs one of triggering an alarm and activating another function of the security circuit if any one of the following conditions are met that include the integrated circuit coming into an operationally-hostile environment, analogous triggering criteria for the sensors are met, and required environmental conditions are lost.

18. The integrated circuit of claim 1, where the integrated circuit is integrated into an identification card.

19. An integrated circuit, comprising:
a memory that stores data;
a power supply that supplies power to the memory to maintain the data stored in the memory when power is supplied thereto; and
a security wire that connects the memory and the power supply device, where when the security wire is interrupted the power supply no longer supplies power to the memory and the data stored in the memory is lost.

20. An integrated circuit, comprising:
a memory that stores data;
a power supply that supplies power to the memory to maintain the data stored in the memory when power is supplied thereto; and
a security circuit that, when power to the memory is interrupted from the power supply, takes action in the form of at least one of destroying at least one of the components of the integrated circuit and erasing the data in the memory.
